(19) United States
(12) Patent Application Publication
(10) Pub. No.: US 2009/0006159 A1
(43) Pub. Date: Jan. 1, 2009

(54) Systems and methods for managing communications with internet sales leads

(76) Inventors: L. Thomas Mohr, San Jose, CA (US); Jagdish Rajan, Fremont, CA (US); Timothy D. Weaver, San Jose, CA (US)

Correspondence Address: CARR & FERRELL LLP, 2200 GENG ROAD, PALO ALTO, CA, 94303, US

(21) Appl. No.: 12/215,940

(22) Filed: Jun. 30, 2008

Related U.S. Application Data
(60) Provisional application No. 60/937,856, filed on Jun. 30, 2007.

(51) Int. Cl. G06Q 30/00; G06Q 99/00; G06Q 10/00; G06F 17/30

(52) U.S. Cl. 705/7; 705/1; 705/400; 705/27

(57) ABSTRACT

Exemplary methods for tracking a lead are presented. Such methods include receiving a first contact information, associating the first contact information with a second contact information, sending the second contact information, receiving a first communication, the first communication addressed to the second contact information, in response to receiving the first communication, mapping the second contact information to the first contact information, sending a second communication addressed to the first contact information, receiving a third contact information, associating the third contact information with a fourth contact information, receiving a third communication, the third communication addressed to fourth contact information, and, in response to receiving the third communication comprising the fourth contact information, mapping the fourth contact information to the third contact information, and sending a fourth communication addressed to the third contact information.

Exemplary methods for generating an initial response communication in response to a lead are provided. Such methods include receiving a sales lead comprising specification information of a product, accessing a database comprising local availability of the product; and determining a price quote based at least in part of the specification information and the local availability of the product.

### CROSS-REFERENCE TO RELATED APPLICATION

The present application claims the priority benefit of U.S. provisional patent application No. 60/937,856 filed Jun. 30, 2007, entitled “Intermediary Application. System to Manage Communications with Internet Sales Leads” the disclosure of which is incorporated herein by reference in its entirety.

### BACKGROUND

1. Technical Field

The present invention relates generally to customer relationship management (CRM). Specifically, the present invention relates to the management of sales leads relating to goods and services.

2. Background Art

Many companies are dependent on sales leads to generate new business. In order to generate the new business, it is necessary for these companies to establish immediate and ongoing communications with potential consumers based on the sales leads. The companies that establish such communications before their competitors do increase their likelihood of securing a consumer's purchase of a product or a service.

### SUMMARY OF THE INVENTION

Exemplary methods for tracking a lead are presented. Such methods include receiving a first contact information, associating the first contact information with a second contact information, sending the second contact information, receiving a first communication, the first communication addressed to the second contact information, in response to receiving the first communication, mapping the second contact information to the first contact information, sending a second communication addressed to the first contact information, receiving a third contact information, associating the third contact information with a fourth contact information, receiving a third communication, the third communication addressed to fourth contact information, and, in response to receiving the third communication comprising the fourth contact information, mapping the fourth contact information to the third contact information, and sending a fourth communication addressed to the third contact information.

Exemplary methods for generating an initial response communication in response to a lead are provided. Such methods include receiving a sales lead comprising specification information of a product, accessing a database comprising local availability of the product; and determining a price quote based at least in part of the specification information and the local availability of the product.

### BRIEF DESCRIPTION OF THE DRAWINGS

FIG. 1 illustrates an exemplary architecture for tracking a sales lead including the intermediary role of the intermediary application system.

FIG. 2 illustrates an exemplary embodiment of the intermediary application system.

FIG. 3 illustrates an exemplary method for tracking a sales lead.

FIG. 4 illustrates the mapping of a sales lead to an alias in an exemplary intermediary application system.

FIG. 5 illustrates an exemplary system used to construct an initial response communication as shown in FIG. 1.

FIG. 6 illustrates an exemplary method used to construct an initial response communication.

FIG. 7 illustrates an exemplary use of vehicle price quoting in determining regional vehicle configuration availability.

FIG. 8 illustrates an exemplary application of a particular sophisticated pricing rule.

FIG. 9 illustrates an exemplary method by which vehicle mapping may be conducted.

### DETAILED DESCRIPTION

Companies have traditionally depended on lead sources to generate leads for their business. A lead may be, for example, a tip or a bid, but is usually a sales lead. A sales lead may be an indication of interest from a potential customer concerning the goods or services that the company provides, and thus play an important role. However, companies may become easily overwhelmed with more leads than they may readily process in a timely manner. In the case of online/internet sales leads, it is especially important to respond to sales inquiries as quickly as possible. In addition, after a company's initial response to sales leads, many sales leads do not remain “active,” in that the company no longer has regular interactions or communications with the consumer. However, these sales leads still hold value because a consumer who has once revealed a purchase interest is more likely to ultimately complete a purchase.

The systems and methods described herein aim to establish immediate and ongoing communications with potential consumers through the use of an intermediary application system. Use of an intermediary application system allows for the following::

From the time of receipt of the sales lead until the sale is closed, a closed loop of communication is created wherein the consumer and the company communicate. The intermediary application system creates contact aliases for consumer contact information and for company contact information (for example a sales representative contact information). Thus, when a consumer contacts the company, or vice versa, the contact alias is used in place of the consumer contact information. As such, communications between the consumer and the company go through the intermediary application system. Contact aliases may be tracked as well, and thus a complete communication history between consumer and company is available. Intermediary application apparatus 130 may use this communication history to determine the status of communications at any time.

The company is able to automatically provide detailed and specific answers to sales leads through an initial response communication generated by the intermediary application system. The initial response communication to the consumer is sent after the lead is received. This results in a dramatic increase in the percentage of leads responded to effectively and a significant time savings for the company.

Existing systems used by companies for customer relationship management do not need to be replaced. CRM system capabilities are augmented and the use of the present systems and methods does not require deep system integration.

The fact that communications pass through the intermediary application system enables the intermediary application system to initiate follow-up communications when there has been no communication between a consumer and a sales representative for a length of time. As such, intermediary application system may make use of a dynamically timed communication relevant to the consumer's interests as specified in the sales lead. The intermediary application system may incorporate information provided by a third party in addition to information within the intermediary application system in producing initial response communications or follow-up communications. In addition, in the normal course of interactions with intermediary application system 130, the company may make available to the system new or updated information. The intermediary application system 130 can recognize such information and dynamically update its internal resources upon receipt of the new or updated information.

The systems and methods described herein are with reference to examples that are purely illustrative. It will be apparent to one skilled in the art that various modifications may be made and embodiments may be used in conjunction with the systems and methods presented.

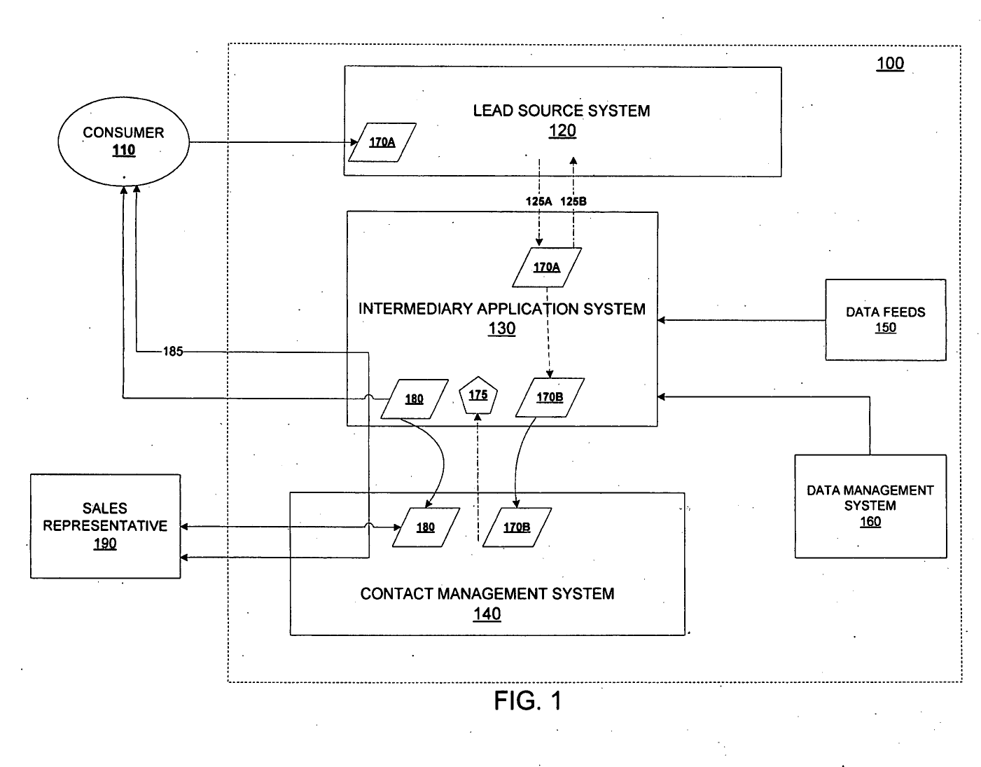

FIG. 1 illustrates an exemplary architecture 100 according to an embodiment of the present invention. The architecture 100 includes a lead source system 120, an intermediary application apparatus 130 and a contact management system 140. The architecture 100 may optionally include a data feed system 150 and a data management system 160. The architecture 100 may be configured on one computer or on multiple computers.

The lead source system 120 may be a company, an application, a website, a service, or some combination that generates or aggregates sales leads and delivers them to a company. Lead source system 120 may also include the company's own lead generation and collection systems, such as the company's website. In FIG. 1, a potential consumer 110 identifies him/herself as a sales lead 170A by entering consumer information using lead source system tools or a website. This consumer information may include the consumer's name, the consumer's contact information, and other consumer information. The contact information received may include an e-mail address, a telephone number, an instant-message screen name, or a website URL. Multiple e-mail addresses and multiple telephone numbers may also be included in sales lead 170A. Other consumer information may be received, such as the consumer's name or her demographic information, in order to facilitate targeted marketing.

The intermediary application system 130 receives the sales lead 170A from lead source system 120. Upon receipt of the sales lead, the intermediary application system 130 associates the consumer contact information from the sales lead 170A to a consumer contact alias. The contact alias may be a randomly generated number, e-mail address, telephone number, or the like. For example, an e-mail address might be username@domainname.com, and the contact alias may be 4567@response.com. The system 130 may also associate other information provided in the sales lead 170A with one or more aliases. Thus, a sales lead containing the consumer contact alias and other alias are used to generate a modified sales lead 170B. This modified sales lead is forwarded to a contact management system 140. Alternatively, only the consumer contact alias may be sent to contact management system 140.

Contact management system 140 may be partially or wholly integrated into the intermediary application system 130. Alternatively, contact management system 140 may be a customer relationship management system belonging to a company. The contact management system 140 recognizes the consumer contact alias and stores information corresponding to consumer 110. In some embodiments, the consumer contact alias for an e-mail address may be embedded in the modified sales lead and sent to the contact management system 140. The contact management system 140 may assign sales lead 170A to a sales representative 190 who may pursue the lead on behalf of the company. Upon receipt of the consumer contact alias, contact management system 140 may request a communication with consumer 110 and initiate the communication using the consumer contact alias. Such a contact management request 175 may provide the contact information of the sales representative 190 who is assigned the lead by the contact management system 140. It is sent to the consumer contact alias, which ensures that it is sent into intermediary application system 130.

Upon receipt of the contact management request 175, intermediary application system 130 receives the contact information of sales representative 190 and associates a sales contact alias to the sales representative's contact information, similar to the consumer contact alias. The intermediary application system 130 generates a response to send to consumer 110, an initial response communication 180. Initial response communication 180 contains, among other information, the sales contact alias of sales representative 190. Communications may be conducted using ordinary tools in the art, such as e-mail, telephone, instant message, SMS, or through a posting on a website. All communications are routed through intermediary application apparatus 130, and then to consumer 110 via process 185. Some forms of communication, such as telephone communication, may involve the engagement of a third-party vendor. The intermediary application system 130 may send the initial response communication 180 on behalf of the company. After the initial response communication 180 is sent, a process or an event may be performed signaling completion. For example, a log activity may be generated in intermediary application apparatus 130. An e-mail may be sent to sales representative 190 to notify her of initial response communication 180 sent to consumer 110.

In some embodiments, a copy of the initial response communication 180 may be sent to contact management system 140. Or, contact management system 140 may be sent details from the initial response communication 180 embedded in the modified sales lead 170B. The contact management system 140 may then associate the consumer contact alias with the copy of initial response communication 180 and stores them in a file or folder. In some cases, contact information of sales representative 190 may not be available. In such cases, initial response communication 180 may provide a sales contact alias that does not point to sales representative 190, but may point to, for example, a company e-mail for inquiries

Consumer 110 may subsequently contact the company or sales representative 190 using the sales contact alias. Such subsequent communication is routed via intermediary application apparatus 130. As such, a closed-loop of communication may be created wherein communication between consumer 110 and sales representative 190 communicate via contact aliases through intermediary application system 130. Communications between consumer 110 and sales representative 190 may continue until a sale is closed. In the event of a closed sale, data management system 160 notifies intermediary application system 130 of a closed sale. Alternatively, consumer 110 may notify sales representative 190 of a closed sale, and follow-up communications may be terminated.

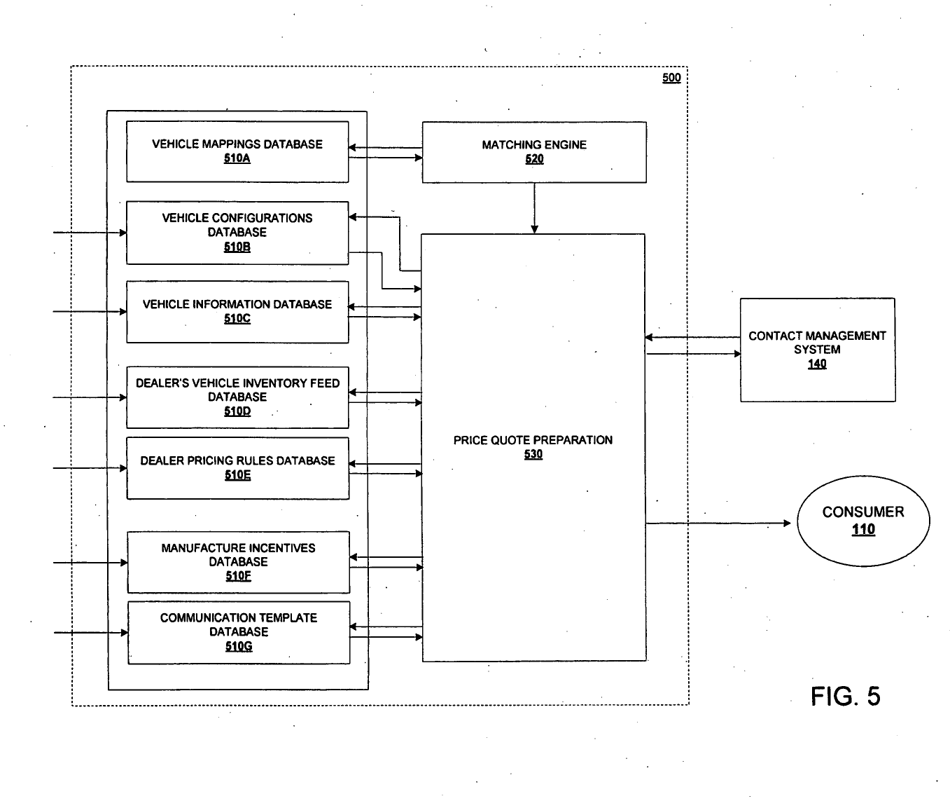

The initial response communication 180 allows for detailed and specific answers to be sent to consumer 110. For example, initial response communication 180 may be a response to sales lead 170A where consumer 110 makes a price quote request. In order to provide a comprehensive response to a request as complex as a price quote, initial response communication 180 may incorporate information from several sources, including but not limited to intermediary application system 130, data management system 160 and data feeds 150. The contents of initial response communication 180 will be discussed in the context of generating an automated price quote for a vehicle in FIGS. 5-9.

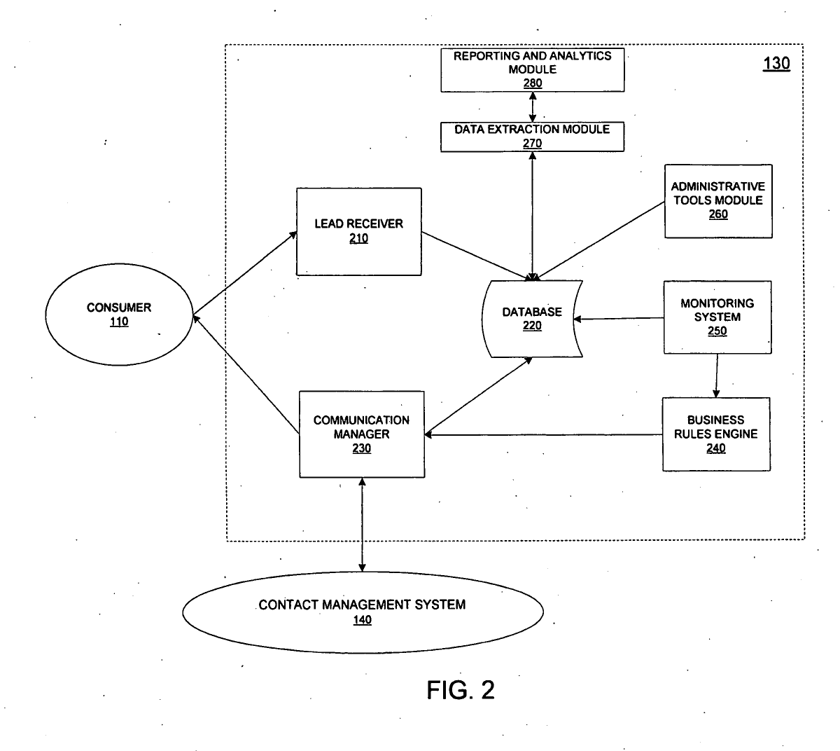

FIG. 2 shows an embodiment of intermediary application system 130. The intermediary application system 130 includes in this embodiment at least a lead receiver 210, a database 220, a communications manager 230, a monitoring system 250, a business rules engine 240, an administrative tools module 260, a data extraction module 270, and a reporting and analytics module 280.

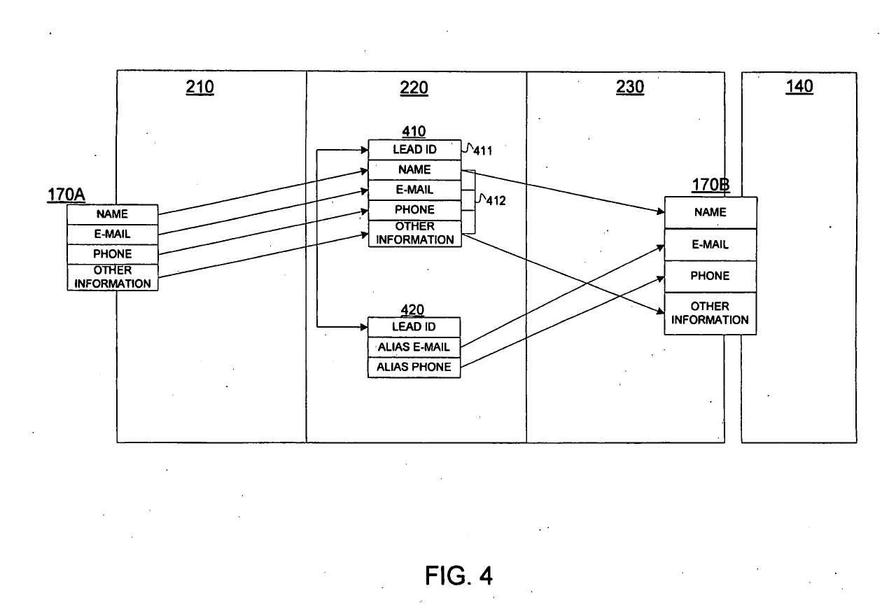

When the intermediary application apparatus 130 receives a sales lead 170A it is processed by lead receiver 210. A sales lead 170A may be received by a “push” approach 125A where the apparatus receives the sales lead, or a “pull” approach 125B where the apparatus obtains the lead after pursuing a potential consumer 110. Lead receiver 210 may be a lead parser that identifies or separates contact information from the sales lead 170A. Lead receiver 210 checks the sales lead 170A to ensure that all the necessary information is included to generate a complete sales lead record. If all data is not present for the record, then the receipt of the incomplete lead is logged and/or an alert is produced. Lead receiver 210 may then check another sales lead. Lead receiver 210 creates entries in the database 220 to store the consumer information and associate the consumer contact information with a consumer contact alias. The lead receiver may also associate other information, such as the consumer's name, with an alias. The process by which the lead receiver 210 associates an alias to contact information in the sales lead is shown in FIG. 4.

The database 220 stores information relating to the other components in the intermediary application apparatus 130 and may accept inputs from at least a contact management system 140, a company's data management system 160, and data feeds 150 from third parties outside the architecture 100. In some embodiments, database 220 is a central repository with data related to several companies that make use of an intermediary application system 130. In some embodiments, the intermediary application system 130 may store data relating to potential consumers relating to one company only. Consumer information such as consumer name, demographic information, and contact information may be stored in database 220. Business rules, or criteria set by a company to govern communications, may also be stored in the database 220. The database may be a single standalone database or a distributed database stored across multiple database servers.

The communication manager 230 is responsible for tracking communication in the database 220 and initiating automatic action on behalf of the company. The communication manager allows for light integration with any contact management system 140. Light integration may occur with contact management system 140 as a result of the aliasing methodology discussed earlier wherein contact information is associated with contact aliases. In one embodiment, light integration is also advanced by embedding details of initial response communication 180 in modified sales lead 170B. Similarly, light integration may be made with lead source system 120 as a result of standard e-mail and lead exchange formats.

The communication manager 230 transmits the consumer contact alias to contact management system 140. When a contact management request 175 is received, the communication manager 230 maps between the consumer contact alias and the consumer contact information in database 220. In some embodiments, other information may be aliased and stored in database 220. A communication is generated and sent to consumer 110. Communication manager 230 may include various components, such as an e-mail component having access to a SMTP server, to facilitate generating and sending communications. The communication manager 230 generates a log of communication activity in the database 220. This information may include the date and time telephoned or e-mailed, which contact information was used, and whether consumer 110 responded to the communication. As such, the communication manager 230 is capable of reporting to the database with respect to sales lead 170A.

In some embodiments, the intermediary application system 130 may automatically initiate action such as a communication on behalf of a company based on one or more business rules. Business rules may be general in nature, for example, a rule to follow-up after a lead has been inactive for thirty days. Business rules may be specific to a particular company for example, Company X providing a special pricing to a consumer 110 who is a member of a local charity group, wherein members of that local charity group qualify for the special pricing. When automatically initiating action, the intermediary application system 130 may make use of at least an administrative tools module 260, a monitoring system 250, and a business rules engine 240.

For instance, a business rule defined in the administrative tools module 260 may have criteria stating that an automatic follow-up communication must be performed when the consumer 110 has not been contacted for thirty days. If monitoring system 250 determines that the criteria for the business rule has been met, the business rules engine 240 composes an appropriate message to the consumer 110. The business rules engine 240 may also determine the necessary elements, such as company graphics, to accompany the message. An appropriate message may be “You expressed interest in our product 30 days ago. We have not been in contact in awhile. Are you still interested?” The business rules engine 240 may then dictate that a copy of this communication is sent to the contact management system 140. If the consumer responds to the message, the communication manager 230 generates an activity log of this communication and, based on business rules, send the message to the contact management system 140 where the sales representative 190 would typically initiate further communication, as shown in FIG. 1.

The administrative tools module 260 allows for input into the database 220. This input may include business rules, other activity relating to sales leads pertaining to the company, and input related to managing company-specific templates used to govern automatic execution of actions. These inputs may be manually entered, selected from a generic list as previously stored in database 220, or a combination of both. A business rule may be defined by the company or an entity authorized by the company, for example a manufacturer or intermediary application system 130 owner.

The monitoring system 250 checks the database 220 to determine when an automatic communication must be sent on behalf of the company. The monitoring system 250 checks the database for reports from the communication manager 230. It compares a report from the communications manager 230 with the corresponding business rule defined by the administrative module to ascertain whether the business rule has been met.

The business rules engine 240 determines the action to be taken on the sales lead 170A based on the findings of the monitoring system 250. The business rules engine 240 then engages the communication manager 230 to fulfill the communication.

The reporting and analytics module 280 generates external reports such as those related to company performance, company benchmarking, and other market analytics. Reporting and analytics module 280 is used to evaluate effectiveness of the intermediary application apparatus 130 and generates such reports for the purpose of continuous system improvement and updates to financial systems. Reporting and analytics module 280 may make use of business rules to determine effectiveness and as such may also include data extraction module 270. Data extraction module 270 retrieves information from database 220, applies a transformation to the data according to at least one business rule, and stores the transformed data in the reporting database of database 220. This transformed data is accessed by reporting and analytics module 280 when generating reports.

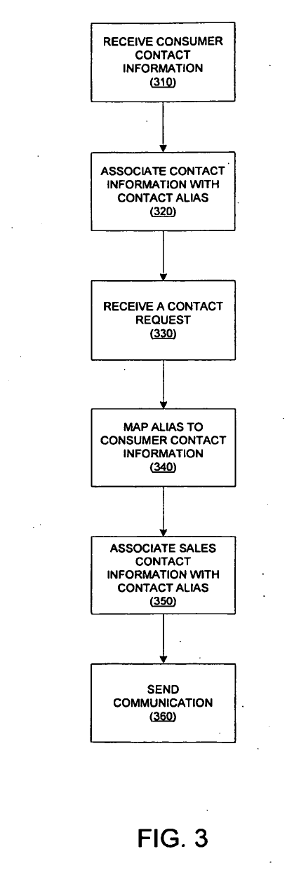

FIG. 3 illustrates an exemplary method of tracking a sales lead according to an embodiment of the invention. In 310, the sales lead 170A containing consumer contact information is received from consumer 110. In 320, the contact information in the sales lead is associated with a consumer contact alias. A modified sales lead 170B is generated with the consumer contact alias or aliases embedded therein. The modified sales lead 170B is sent to contact management system 140. In 330, a contact management request 175 may be received by communication manager 230. In some embodiments, the contact management request 175 may be sent from the contact management system 140. The communication response may contain the contact information of a sales representative 190. In 340, the consumer contact alias and other associated aliases may be mapped to the consumer contact information and other information. In 350, the contact information of sales representative 190 is associated with a sales contact alias. In 360, a communication is sent to consumer 110. Sending the communication 360 may entail composing or selecting an appropriate template for a message, incorporating the sales contact alias into the message, transmitting the communication, and logging an event in database 220. In some embodiments, performance of communication 360 may entail logging the communication as an event in database 220 and tracking it in 360. Likewise, other events may include sending a confirmation e-mail, updating a counter, or the like.

FIG. 4 illustrates an exemplary method by which trackable consumer contact aliases are created by lead receiver 210. When sales lead 170A is received by lead receiver 210, it may parse and extract the consumer's contact information. Lead receiver 210 makes a unique lead insertion into a lead table 410 in the database 220 and assigns sales lead 170A a lead ID 411. The lead table may store an unlimited amount of consumer contact information and other information, 412. Lead ID 411 is used to generate an entry into an alias table 420 in database 220. The alias table 420 assigns a unique alias to the consumer's e-mail and telephone, thus creating modified sales lead 170B. The generation protocol of aliases for e-mail or telephone information may be established either by a component of the intermediary application apparatus or via a third party outside the intermediary application apparatus. When the communications manager 230 receives a request from the contact management system 140, it maps between lead table 410 and the alias table 420, thus sending the consumer contact alias instead of the actual contact information. Similarly, the sales contact alias may also be created when contact management request 175 is received by communications manager 230. Communications manager 230 may then parse the lead for at least the contact information of sales representative 190 and make an insertion in lead table 410, thereby repeating the process described above. Communications manager 230 may generate an activity log in the database 220 indicating that a follow-up event has occurred.

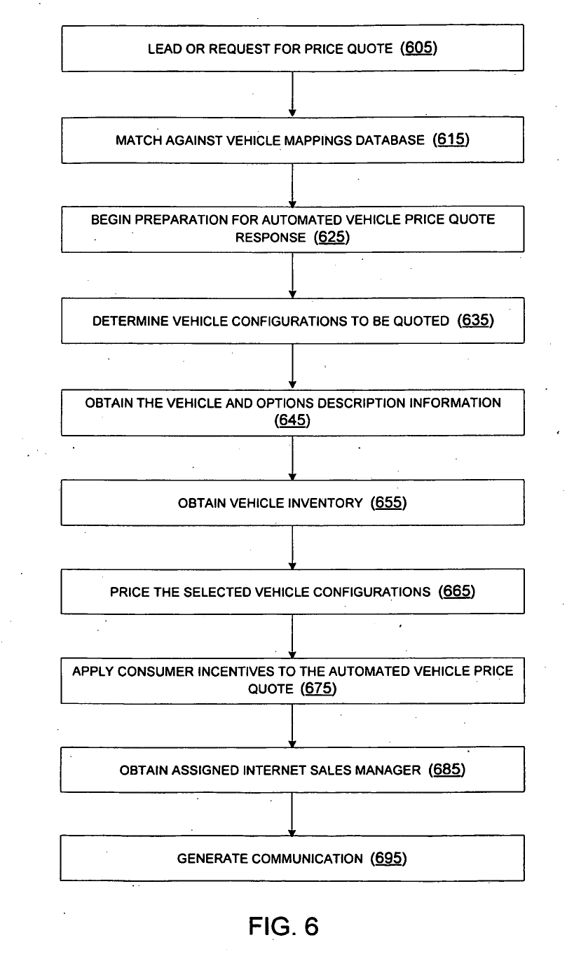

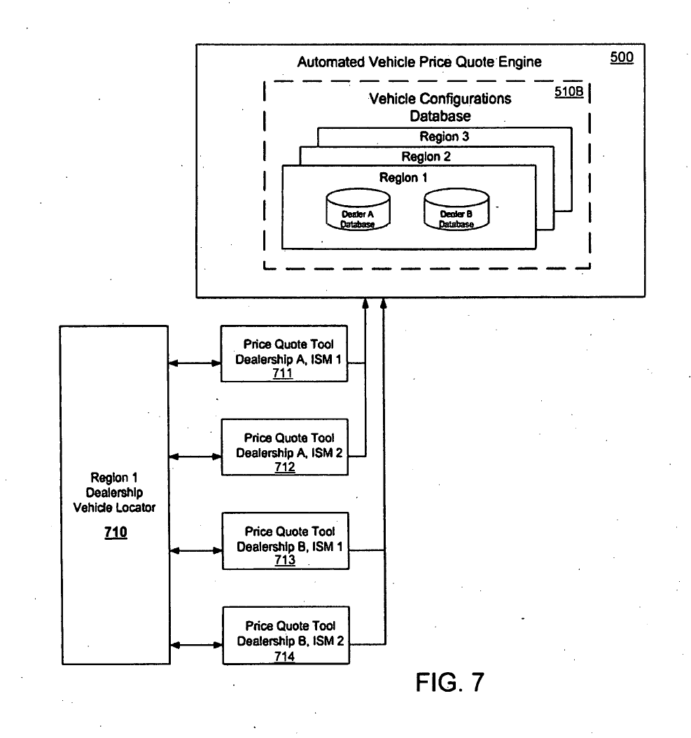

The systems and methods described above may be used in any situation where an in-depth response to sales lead 170A may be helpful. An example of such an in-depth response, as mentioned before, is generating a price quote for a product such as a good or a service. Such in-depth responses can find applicability in issuing or generating quotes for mortgages, real estate, or the like. In the embodiment discussed herein, the systems and methods are used in the context of the automotive business for generating a vehicle price quote (initial response communication 180) in response to a price quote request (sales lead 170A). FIG. 5 illustrates a component of intermediary application system 130, the automated vehicle price quote engine 500. The automated vehicle price quote engine 500 may be used to automatically issue an initial response communication 180 based on sales lead 170A. Automated issuance of a vehicle price quote may provide a vehicle dealer or dealership with more pricing flexibility, greater accuracy, and significant time savings. FIG. 6 illustrates an exemplary method by which a vehicle price quote may be automatically issued. FIGS. 7-9 illustrate further capabilities of vehicle price quote engine 500.

The automated vehicle price quote may involve identifying the following based on the vehicle specified in sales lead 170A:
What vehicles are available, in the geographical region from where the lead was originated or at a nearby vehicle dealership, that would satisfy the request in sales lead 170A.
What features and options are equipped on the vehicles to be quoted.
Whether the vehicles being quoted qualify the consumer for manufacture incentives such as cashback rebates, special financing options, and/or special lease rates.
What vehicle price quote will be communicated by the dealership in the vehicle price quote, and calculating that price quote.
On behalf of which sales representative at a dealership the vehicle price quote will be issued.
   Information relating to the above factors may be preexisting in the intermediary application system 130 or provided by various third-party sources.

FIG. 5 shows an embodiment of automated vehicle price quote engine 500 wherein the information is collected, processed, and stored in databases 510A-510G. In some embodiments, the information may be stored in database 220 in one database or a series of databases as discussed in FIG. 2.

Vehicle mappings database 510A contains the translations of vehicle representation understood by the automated vehicle price quote engine 500. For example, if the automated vehicle price quote engine 500 understands a vehicle to be a 2009 Toyota Corolla LE 4-Door Sedan and the supplier of a vehicle price quote request destined for a given dealership understands the same vehicle as a 2009 Toyota Corolla LE 4-dr SDN; then, a translation from one representation to another may take place:

2009 Toyota Corolla LE 4-dr SDN=2009 Toyota Corolla LE 4-Door Sedan

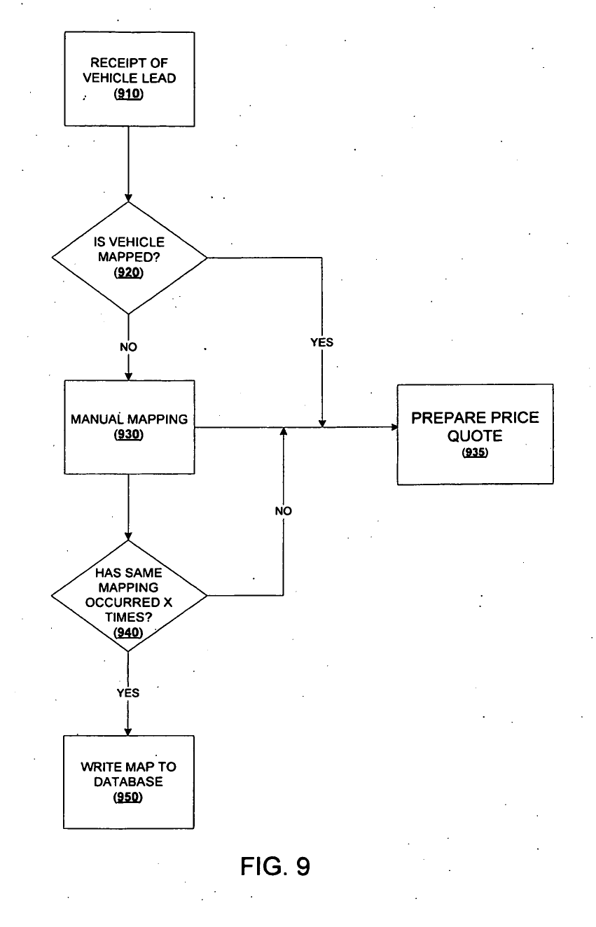

This mapping is conducted by matching engine 520. Once this mapping has taken place, an incoming request may automatically be matched to vehicles available at the dealership or within the geographical region. In some embodiments, new vehicle mappings may be added to vehicle mappings database 510A to create a repository of various translations corresponding to a particular vehicle. This process is exemplified in FIG. 9.

Vehicle configurations database 510B is a repository that stores information relating to various specification information such as combinations of options/features built by the vehicle's manufacturer. The configurations may be stored in the form of specific vehicles as uniquely identified by their VIN number or vehicle configurations that are available at a given dealership or across multiple dealerships. For a given combination of “Year, Make, Model” or “Year, Make, Model, Trim,” this database may contain multiple vehicle configurations. Some or all of these configurations may be presented in the automated vehicle price quote response. In some embodiments, new configurations may be added to vehicle configurations database 510B due to the use of automated vehicle price quote engine 500. This process is exemplified in FIG. 7.

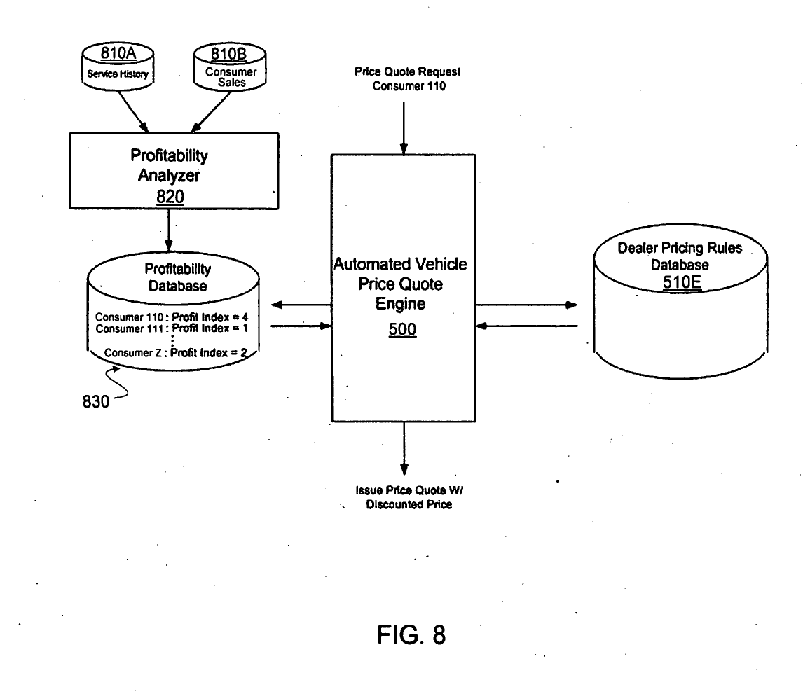

Dealer pricing rules database 510E contains the rules and the pricing values by which the dealer arrives at the final price of a given vehicle. These rules are stored in advance of an incoming vehicle price quote request. Examples of sophisticated pricing and the application of such rules in providing an automated quote are described in FIG. 8.

Communication template database 510G is stored in advance of the issuance of an automated vehicle price quote. The template may contain information layout, copy, graphics or the like that-may be used at the time a vehicle price quote request has been issued. The communication method used to inform the recipient of a vehicle price quote may be e-mail, webpage, text message, mobile communication and other forms of communication commonly used in the art.

In some embodiments, other databases may be used in conjunction with those discussed above.

Vehicle information database 510C may describe a given vehicle or compare it to other vehicles. The information in 510C provides consumer 110 of the vehicle price quote with the vehicle's description as well as the descriptions of the options, features, and equipment contained on the quoted vehicles. Vehicle information database 510C may be provided a third-party company.

Dealer's vehicle inventory feed database 510D contains the list of vehicles both new and used currently at a given dealership's location along with information that may be obtained by decoding the vehicle identification number (VIN) number associated with each vehicle. This database is used to provide information relating to actual new and used vehicles on the dealer's lot that may match a purchase interest. In some embodiments, comparable used vehicle alternatives that match the new vehicle equivalent based on inventor's algorithms may be presented.

Manufacturer incentive database 51OF contains vehicle manufacturer incentives offered directly to consumer 110. These incentives may include cash back rebates, special financing rates, or special lease rates to influence a consumer's purchase decision.

FIG. 6 illustrates an exemplary method by which the automated issuance of a vehicle price quote is created.

In 605, a request for an automated vehicle price quote, such as sales lead 170A from consumer 110, is received and analyzed. Consumer 110 provides specification information, such as make, model, and trim of the vehicle to assist in determination of the vehicle. The vehicle for which a price quote is being requested is determined.

In 615, the request is compared with the vehicles contained in Vehicle Mappings Database 510A. The requested vehicle is automatically mapped to one that is understood by the automated vehicle price quote engine. If a match occurs, the preparation for a vehicle price quote begins in 625.

In 635, the automated vehicle price quote engine 500 determines which vehicle configuration or configurations will be quoted as determined in advance either by the dealership or a preprogrammed selection algorithm.

In 645, the automated vehicle price quote engine obtains the description of the vehicles and options descriptions from the vehicle information database 510C in order to present this information in the communication to consumer 110.

In 655, the automated vehicle price quote engine obtains vehicle inventory from the Dealer's Vehicle Inventory Feed Database 510D.

In 665, the dealer's pricing rules are applied by the automated vehicle price quote engine 500. The pricing rules may contain absolute selling price, pricing relative to the vehicle's MSRP, or pricing relative to the dealer's invoice price. Dealer invoice pricing may be obtained from the dealership in absolute fashion or through a formulaic calculation. Dealer's pricing rules are further discussed in FIG. 8.

In 675, consumer incentive information is accessed from the Manufacture Incentive Database 510F and applied to the final price quote. This information may include but is not limited to cash back rebates, special financing rates, or special lease rates.

In 685, if the dealership desires the vehicle price quote response to come on behalf of a specific assigned individual at the dealership such as sales representative 190, the automated vehicle price quote engine 500 may obtain this information from a contact management system 140 such as the dealership's internet lead management (ILM) or customer relationship management (CRM) software as explained in Sections <0022> and <0023> above. The contact management system 140 may be a company's ILM/CRM system. The automated vehicle price quote engine 500 may inform dealership personnel as to which vehicles were identified in initial response communications 180, and what the corresponding price quotes were.

The automated vehicle price quote engine sends the Internet lead/quote request into the dealership's ILM/CRM after having modified the lead/quote request to specify the vehicles and their corresponding price quotes that will be communicated to the vehicle shopper.

In 695, an initial response communication 180 for the vehicle price quote is generated and sent by selecting a template from the Communication Template Database 510G. The information for the vehicle price quote is incorporated into the template dynamically to produce the desired vehicle price quote communication. The communication may be issued via e-mail, web, SMS, text, mobile communication and others known in the art.

FIGS. 7-9 illustrate further embodiments of elements discussed in FIGS. 5 and 6. FIG. 7 illustrates the use of vehicle price quoting in determining regional vehicle configuration availability. FIG. 8 illustrates the application of a particular sophisticated pricing rule. FIG. 9 illustrates a method by which vehicle mapping may be conducted.

FIG. 7 illustrates the use of vehicle price quote engine to create a database with a regional view of available vehicle configurations. While it is possible for a vehicle shopper to specify a desired vehicle configuration, the vehicle's manufacturer may not have built such a configuration. Understanding the availability of vehicle configurations for a given region may be useful in automating the generation of a vehicle price quote. By providing a follow-up price quote tool as presented in this application, many sales representatives 190 at many dealerships of the same manufacturer in a geographical region may frequently issue quotes to consumers on vehicles a sales representative 190 has confirmed are available in the region.

In some embodiments, a dealership's sales representative 190 may request the issue of a vehicle price quote. The sales representative 190 may select an existing vehicle configuration contained in the vehicle configurations database 510B or create a new vehicle configuration as part of the request to issue an automated vehicle price quote. Alternatively sales representative 190 may perform a regional vehicle search using a tool such as a manufacture provided regional vehicle locator 710 prior to creating a vehicle configuration to be quoted. The manufacture-provided regional vehicle locator 710 shows sales representative 190 the inventory of vehicles available across all the dealerships within the region. Upon locating a vehicle in the region, sales representative 190 may input this vehicle configuration into the automated vehicle price quote engine. When sales representative 190 provides the vehicle configuration and requests the issuance of a vehicle price quote, this vehicle configuration is passed along to the automated vehicle price quote engine 500 and stored within vehicle configurations database 510B.

In some embodiments, a feedback mechanism is implemented from the issuance of vehicle price quotes by multiple sales representatives 190 at multiple dealerships in a given region. The vehicle configurations database 510B may approximate the vehicle configurations available in a given region as-in the manufacture provided regional vehicle locator. The matching algorithm as executed by matching engine 520 may be improved over time providing a better match for an internet lead initiated vehicle price quote request either automatically or via manual input.

FIG. 8 illustrates an embodiment of the automated vehicle price quote engine 500 that allows sophisticated pricing decisions to be easily and readily implemented. A dealership may provide sophisticated pricing rules to a vehicle shopper such as consumer 110. These rules may be stored in database 510E, or the rules may be stored as business rules in database 220. An exemplary sophisticated pricing rule may be to offer special vehicle pricing based on the source of the vehicle price quote request, such as the American Automobile Association website. A sophisticated pricing rule may have strategic and practical applications for a dealership. An example may be to issue a price quote based on the vehicle shopper's zip code contained in the vehicle price quote request. By issuing a lower pricing, a dealership may entice a shopper to drive a greater distance to do business with the dealership.

A sophisticated pricing rule may be based on a vehicle shopper's past profitability or perceived future profitability. The automated vehicle price quote engine may provide the mechanism to issue vehicle price quote incorporating the concept of consumer profitability. For example, if consumer 110 purchased a vehicle and had it serviced regularly by a dealership, consumer 110 would be considered more profitable than a consumer who did not purchase or service her vehicle at the dealership. If consumer 110 purchases her next vehicle from the same dealership, consumer 110 may continue to be a profitable consumer. By offering a lower price quote to consumer 110, the dealership may encourage this profitable consumer to purchase from the same. Likewise, previous consumers may be analyzed to determine profitability by obtaining sales and service information from a dealership database, such as service history database 810A or consumer sales database 810B as pictured in FIG. 8. In some embodiments, the profitability of a dealership consumer may be determined via a profitability analyzer 820 and stored in a profitability database 830. Profitability database 830 may store information relating to consumer profitability in the form of profitability indices. For example, a profitability index may be a rating based on a numeric scale incremented from 1 to 4, with 1 as the least profitable and 4 as the most profitable. This index may be accessible to the automated vehicle price quote engine 500, which in turn may access the dealer pricing rules database 510E to associate a percentage discount with each rating.

In some embodiments, consumer 110 submits a request for an automated vehicle price quote to a dealership providing automated vehicle price quotes based on consumer profitability. The automated vehicle price quote engine 500 queries the profitability database 830 for to determine if consumer 110 is present in the profitability database. In this example, the query returns a match with a high level of profitability for consumer 110. The dealer pricing rules database may be checked and the pricing discount applied to the vehicle price quote provided to consumer 110. The vehicle price quote is issued containing the applied discount based on consumer profitability.

FIG. 9 illustrates an exemplary method by which vehicle mapping may be conducted on a vehicle price quote request as received in 910. As discussed earlier, a vehicle price quote request, such as sales lead 170A, contains a representation of a vehicle for which a quote is desired. In 920, the automated vehicle price quote engine 500 is accessed to determine if the vehicle can be identified from the representation made in the vehicle price quote request. If the vehicle can be identified, a translation exists for the vehicle specified in the price quote request in the vehicle mappings database 510A. The requested vehicle is automatically matched to the translation, the appropriate vehicle configurations are selected from 510B, and a price quote is generated in 935. If the vehicle cannot be identified, the vehicle mappings database 510A does not include a translation for the specified vehicle, and the lead information is used to manually translate in 930. The price quote is then generated in 935. The manual translation may involve a user of intermediary application system 130 evaluating the vehicle information contained in the lead and selecting the corresponding translation understood by the automated vehicle price quote engine 500. In one embodiment, the map may be written to the vehicle mappings database 510A such that automated matching may occur. In optional 940, automatic matching may occur after manual translation has occurred for the same vehicle a number of times. This translation may be written to the vehicle mappings database 510A in 950. As such, the manual process may be used to teach the automated vehicle price quote engine to identify vehicles based on representations in sales lead 170A, and use the correct translations without the use of manual mapping.

The systems and methods described above have been described with the use of illustrative examples. It is apparent that obvious modifications may be made and still be within the scope of the invention. For example, there may be a situation where a consumer 110 may wishes to track communication or automatically communicate with one or more sellers. In this scenario, a company may provide contact information to the consumer using an intermediary application system 130. Multiple contact aliases may be assigned to a contact information. For example, an e-mail address may be assigned multiple aliases, and each alias may be sent to a different sales representative. By tracking the alias using intermediary application system 130, it would be possible to gauge each sales representative's success at closing a sale. Initial response communication 180 may also be customized to facilitate targeted marketing. For example, a consumer 110 may be profiled using various services known in the art. Such profiles may be, for example a cost-conscious consumer 110 or a feature-driven consumer 110. By profiling consumer 110, a message may be sent in initial response communication 180 that may offer discounts, attractive photographs of features, etc. in order to encourage consumer 110 to purchase the product. These and other modifications are intended to be covered in the scope of the present application.

What is claimed is:

1. A method for sales lead management, the method comprising:
receiving a first contact information;
associating the first contact information with a second contact information;
sending the second contact information;
receiving a first communication, the first communication addressed to the second contact information;
in response to receiving the first communication:
mapping the second contact information to the first contact information;
sending a second communication addressed to the first contact information;
receiving a third contact information;
associating the third contact information with a fourth contact information;
receiving a third communication, the third communication addressed to fourth contact information; and
in response to receiving the third communication comprising the fourth contact information:
mapping the fourth contact information to the third contact information;
sending a fourth communication addressed to the third contact information.

2. The method of claim 1, wherein the first contact information is an e-mail address for a first person or entity and the third contact information is an email address for a second person or entity.

3. The method of claim 1, wherein the second contact information is a first alias email address comprising a first user name and a first domain name and the fourth contact information is a second alias email address comprising a second user name and a second domain name, wherein the first domain name and the second domain name point to an email server, the first user name and the second user name corresponding to unique user names on the email server.

4. The method of claim 1, wherein the first contact information is a phone number for the first person or entity and the third contact information is a phone number for the second person or entity.

5. The method of claim 1, wherein the second contact information is an alias phone number for the first person and the third contact information is an alias phone number for the second person.

6. The method of claim 1, further comprising receiving a sales lead, wherein the sales lead comprises the first contact information.

7. The method of claim 6, wherein the second communication comprises an initial response communication.

8. The method of claim 7, wherein the initial response communication is addressed to the first contact information and comprises the fourth contact information, the fourth contact information parsed from the first communication.

9. The method of claim 1, further comprising logging at least one of the first, second, third or fourth communications.

10. The method of claim 1, further comprising sending a communication after a predetermined period during which no communications have been addressed to the second contact information or the fourth contact information.

11. The method of claim 6, further comprising receiving an indication of a sale and associating the indication of the sale with the sales lead, the indication of a sale being generated in response to an order entry comprising at least a portion of the second contact information.

12. The method of claim 7, wherein the second communication addressed to the first contact information comprises a personalized quote based on information in the sales lead.

13. The method of claim 7, wherein the second communication addressed to the first contact information comprises a query to the consumer as to further information to generate the personalized quote.

14. A method for price quoting, the method comprising:
receiving a price quote request from a requesting party, the price quote request comprising information concerning a geographic location and a specification of a product;
accessing a database configured to store information concerning availability of the product based on geographic location;
determining a price quote based on a search of the database, the search being based on the information concerning the geographic location and the specification of the product provided by the price quote request; and
providing the determined price quote to the requesting party.

15. The method of claim 14, wherein the product comprises a service.

16. The method of claim 14, wherein the product comprises a vehicle and the specification information comprises at least one of a make, model, trim and option identifications for the vehicle.

17. The method of claim 14, further comprising updating the database based on the specification information in the price quote request.

18. The method of claim 14, wherein the price quote request is-included in a sales leads.

19. The method of claim. 14, wherein the price quote request is provided by a sales representative.

20. The method of claim 14, further comprising updating the local availability based on information provided by a seller of the product.

21. The method of claim 20, wherein the information provided by the seller comprises pricing rules specific to the seller of the product.

22. A method for sales lead management, the method comprising:
receiving a sales lead comprising contact information for a first party;
generating a first alias associated with the contact information;
providing the first alias to a second party;
receiving a contact request including the first alias from the second party;
determining the contact information associated with the first alias; and
forwarding the contact request to the first pasty using the determined contact information.

23. The method of claim 22, wherein the forwarded contact request includes a second alias associated with contact information for the second party.

24. A system for sales lead management, the system comprising:
a lead receiver configured to receive a sales lead comprising contact information and to associate the contact information with an alias;
a database configured to store information concerning the contact information and the associated alias; and
a communications manager configured to:
provide the alias to a contact management system;
receive a contact request comprising the alias;
determine the contact information associated with the alias in the received contact request; and
forward the contact request using the contact information.

25. The system of claim 24, wherein the lead receiver is a lead parser.

26. The system of claim 24, further comprising a monitoring system configured to monitor the database according to one or more business rules.

27. The system of claim 24, further comprising a business rules engine configured to initiate an automatic follow-up communication according to one or more business rules.

28. The system of claim 24, further comprising an administrative tools module configured for the input of one or more business rules.

29. A computer-readable storage medium having embodied thereon a program, the program being executable by a computer to perform a method for sales lead management, comprising:
receiving a sales lead comprising contact information for a first party;
generating a first alias associated with the contact information;
providing the first alias to a second party;
receiving a contact request including the first alias from the second party;
determining the contact information associated with the first alias; and
forwarding the contact request to the first pasty using the determined contact information.

30. The computer-readable storage medium of claim 29, wherein the forwarded contact request includes a second alias associated with contact information for the second party.
